(19) United States
(12) Patent Application Publication
(10) Pub. No.: US 2016/0083518 A1
(43) Pub. Date: Mar. 24, 2016

(54) POLYETHER AMINES USEFUL AS ACCELERANTS IN EPOXY SYSTEMS

(71) Applicant: BASF SE, Ludwigshafen (DE)

(72) Inventors: Jean-Francois STUMBE, Strasbourg (FR); Anna MUELLER-CRISTADORO, Waldems (DE); Guenter SCHERR, Ludwigshafen (DE); Michael HENNINGSEN, Frankenthal (DE); Bernd BRUCHMANN, Freinsheim (DE); Miran YU, Ludwigshafen (DE); Chunhong YIN, Ludwigshafen (DE)

(73) Assignee: BASF SE, Ludwigshafen (DE)

(21) Appl. No.: 14/959,616

(22) Filed: Dec. 4, 2015

Related U.S. Application Data
(63) Continuation of application No. 13/545,619, filed on Jul. 10, 2012, now abandoned.
(60) Provisional application No. 61/508,096, filed on Jul. 15, 2011.

(30) Foreign Application Priority Data
Jul. 15, 2011 (EP) 11174226.8

(51) Int. Cl. C08G 73/02; C08G 59/50

(52) U.S. Cl. CPC C08G 73/024; C08G 59/5026; C08G 59/5006

(57) ABSTRACT

The present invention relates to the speeded curing of a composition comprising an epoxy compound, an amino or anhydride hardener and a high-branched polyether amine accelerant. The high-branched polyether amine may have terminal hydroxyl groups (polyol) and/or amino groups (amino modified). The amino-modified high-branched polyether amines are obtainable by subsequently modifying the terminal hydroxyl groups of high-branched polyether amine polyols.

### CROSS-REFERENCE TO RELATED APPLICATIONS

This application is a Continuation of U.S. Nonprovisional application Ser. No. 13/545,619, which was filed on Jul. 10, 2012. Application Ser. No. 13/545,619 is a Nonprovisional of U.S. Provisional Application No. 61/508,096, which was filed on Jul. 15, 2011. This application is based upon and claims the benefit of priority to European Application No. 11174226.8, which was filed on Jul. 15, 2011, the entire contents of which are incorporated herein by reference.

### BACKGROUND OF THE INVENTION

The present invention relates to a curable composition comprising an epoxy compound, an amino or anhydride hardener and a high-branched polyether amine. The high-branched polyether amine may have terminal hydroxyl groups (polyol) and/or amino groups (amino modified).

The present invention also relates to amino-modified high-branched polyether amines having on average at least 1% and preferably at least 5% of amino groups among the terminal groups, and also to a process for preparing such amino-modified high-branched polyether amines.

The present invention further relates to the process for preparation of cured epoxy resins from the curable composition, to the use of high-branched polyether amines as accelerants for the curing of epoxy resins, and also to cured epoxy resin from the curable composition and to molded articles obtained therefrom. In addition, the curable composition can also be used in adhesive or paint applications.

Epoxy resins are general knowledge and by virtue of their toughness, flexibility, adherence and chemical resistance are used as materials for surface coating, as adhesives and for molding and laminating. Epoxy resins are used in particular for preparation of carbon fiber-reinforced or glass fiber-reinforced composite materials of construction. The use of epoxy resins in casting, potting and encapsulation is also known in the electrical and tool industry.

Epoxy materials are polyethers and are obtainable for example by condensation of epichlorohydrin with a diol, for example an aromatic diol such as bisphenol A. Epoxy resins are subsequently cured by reaction with a hardener, typically a polyamine (U.S. Pat. No. 4,447,586, U.S. Pat. No. 2,817,644, U.S. Pat. No. 3,629,181, DE 1006101, U.S. Pat. No. 3,321,438).

Various curing techniques are known. For example, epoxy compounds having two or more epoxy groups can be cured with an amino compound having two amino groups in a polyaddition reaction (chain extension). Amino compounds of high reactivity are generally only added shortly before the desired curing. These systems are therefore known as two-pack systems. An alternative is to use so-called latent hardeners, for example dicyandiamide or various anhydrides, which are only active at high temperatures, which avoids undesired premature curing and makes one-pack systems possible.

There is an immense need for compositions whereby the curing of the epoxy resin can be exactly policed and adjusted in respect of the desired requirements. For instance, in the fabrication of large structural components in particular, the increase in viscosity during the processing time must not be so large that the complete filling of the mold or the adequate wetting of the composite fibers is no longer ensured. At the same time, the cycle time, i.e., the time for processing plus curing, must not be adversely affected.

The rate of stoichiometric curing of epoxy compounds with amino hardeners can be increased by incorporating in the composition tertiary amines which act as accelerants. Triethanolamine, benzyldimethylamine, 2,4,6-tris(dimethylaminomethyl)phenol and tetramethylguanidine are described as examples of such accelerants (U.S. Pat. No. 4,948,700). U.S. Pat. No. 6,743,375, however, teaches a person skilled in the art that tetramethylguanidine is a comparatively weak accelerant. One disadvantage in using these accelerants is that they, after curing, can migrate within the cured epoxy resin. Unwanted aging processes and worse material characteristics due to the accelerants which are the nonuniformly distributed in the ready-cured epoxy resin and also unwanted release of these chemicals from the cured epoxy resin are the consequence. Using these compounds is also problematic during processing, since their high volatility can lead to emissions which are an odor nuisance, a health hazard and/or flammable. This is a problem particularly with the use of toxic or statutorily regulated compounds, for example triethanolamine.

It is an object of the present invention to provide additives for compositions comprising epoxy compounds and amino or anhydride hardeners whereby curing can be speeded in a controlled manner without the disadvantages of known accelerants.

### BRIEF SUMMARY OF THE INVENTION

The present invention accordingly provides curable compositions comprising one or more epoxy compounds, one or more amino or anhydride hardeners and an addition of one or more high-branched polyether amines. The high-branched polyether amines of the present invention are high-branched polyether amine polyols having terminal hydroxyl groups or are derivatives thereof wherein the terminal hydroxyl groups are wholly or partly modified. The terminal hydroxyl groups of the derivatives are preferably modified such that the corresponding polyether amine has primary and/or secondary amino groups in the terminal position. The high-branched polyether amine polyol derivatives of the present invention are preferably amino-modified high-branched polyether amines.

The invention also provides processes for preparation of cured epoxy resins from the curable composition of the present invention by curing the composition. Curing is preferably effected thermally by heating the composition at least to a temperature at which the amino groups or the anhydride groups of the hardener and the epoxy groups of the epoxy compound react with each other. Curing can take place at atmospheric pressure and at temperatures below 250° C., more particularly at temperatures below 210° C., preferably at temperatures below 185° C. and in particular in the temperature range from 40 to 210° C. The curing of molded articles typically takes place in a mold to the point of dimensional stability being attained and the workpiece can be removed from the mold. The extent of curing can be determined via differential scanning calorimetry (DSC) by measuring the released energy of reaction. Alternatively, rheological analyses, pot life measurements or determinations of viscosity can also be used to determine the extent of curing. Curing can also be effected using non-thermal processes, for example by microwave treatment.

The invention further provides for the use of high-branched polyether amines as additive in a curable composition comprising one or more epoxy compounds and one or more amino or anhydride hardeners to speed the curing. Unexpectedly, the macromolecular high-branched polyether amines effectuate a distinct speeding of the curing process. Compared with the curable composition without the addition of high-branched polyether amines, the time to complete curing or to achieving a defined viscosity (10 000 mPas for example) under otherwise identical curing conditions shortens by at least 5%, preferably by at least 10% and more preferably by at least 20%.

The invention further provides cured epoxy resins obtainable by completely or partially curing the curable composition of the invention. Curing is preferably performed until a viscosity of at least 10 000 mPas or until dimensional stability is achieved. The invention provides cured epoxy resins from the curable composition of the invention. The cured epoxy resins can be present as molded articles, optionally as composite materials of construction which comprise glass or carbon fibers.

### DETAILED DESCRIPTION OF THE INVENTION

The high-branched polyether amine polyols of the invention, which bear a multiplicity of functional groups, are obtained from trialkanolamines with or without mono- or dialkanolamines. To this end, these monomers are etherified catalytically (acid or basic catalysis) with elimination of water. The preparation of these polymers is described for example in U.S. Pat. No. 2,178,173, U.S. Pat. No. 2,290,415, U.S. Pat. No. 2,407,895 and DE 40 03 243. The polymerization can either be carried out to produce a random polymer, or to form block structures from individual alkanolamines, which are linked together in a further reaction (U.S. Pat. No. 4,404,362).

Trialkanolamines such as, for example, triethanolamine, tripropanolamine, triisopropanolamine or tributanolamine are used as starting material for the synthesis of high-branched polyether amine polyols, optionally in combination with dialkanolamines, such as diethanolamine, dipropanolamine, diisopropanolamine, dibutanolamine, N,N′-dialkanolpiperidine, or in combination with di- or more highly functional polyetherols based on ethylene oxide and/or propylene oxide. Preferably, however, triethanolamine and triisopropanolamine or their mixture is used as starting material. After the reaction, i.e. without further modification, the high-functionality high-branched polyether amine polyols have terminal hydroxyl groups.

Terminal groups for the purposes of this invention are free, reactive groups (end groups or side groups), for example hydroxyl groups, primary or secondary amino groups, of end-disposed monomer units—or of reagents coupled to end-disposed monomer units—of the high-branched polyether amine.

Alkanol groups for the purposes of this invention are aliphatic radicals, preferably having 1 to 8 carbon atoms, a hydroxyl group and no further heteroatoms. The radicals can be linear, branched or cyclic and saturated or unsaturated.

A high-branched polyether amine polyol for the purposes of this invention is a product which, in addition to the ether groups and the amino groups, which form the polymer scaffold, further has, in a terminal position, at least three, preferably at least six, more preferably at least ten and even more preferably at least 20 hydroxyl groups. The number of terminal hydroxyl groups has no upper limit in principle, but products having a very large number of hydroxyl groups can have undesired properties, for example high viscosity or poor solubility. The high-branched polyether amine polyols of the present invention usually have not more than 500 and preferably not more than 150 terminal hydroxyl groups.

The polyether amine polyols are either prepared in solution or preferably without a solvent. Useful solvents include aromatic or aliphatic (including cycloaliphatic) hydrocarbons and mixtures thereof, halogenated hydrocarbons, ketones, esters and ethers.

The temperature involved in the synthesis should be sufficient for reacting the alkanolamine. The reaction temperature is generally in the range from 100° C. to 350° C., preferably in the range from 150 to 300° C., more preferably in the range from 180 to 280° C. and specifically in the range from 200 to 250° C.

The water released in the course of the reaction, or low molecular weight products of the reaction can be removed from the reaction equilibrium, for example distillatively, at atmospheric or reduced pressure, to speed and complete the reaction. Removal of water or of low molecular weight products of the reaction can also be assisted by passing through the mixture a gas stream that is essentially inert under the reaction conditions (stripping), for example nitrogen or noble gases such as helium, neon or argon.

Catalysts or catalyst mixtures can also be added to speed the reaction. Suitable catalysts are compounds that catalyze etherification or transetherification reactions, examples being alkali metal hydroxides, alkali metal carbonates, alkali metal bicarbonates, preferably of sodium, of potassium, or cesium, and also acidic compounds such as iron chloride or zinc chloride, formic acid, oxalic acid or phosphorus-containing acid compounds, such as phosphoric acid, polyphosphoric acid, phosphorous acid or hypophosphorous acid. Preference is given to using phosphoric acid, phosphorous acid or hypophosphorous acid, optionally in water-diluted form.

The catalyst is generally added in an amount of 0.001 to 10 mol %, preferably from 0.005 to 7 mol % and more preferably 0.01 to 5 mol %, based on the amount of alkanolamine or alkanolamine mixture used.

It is also possible, furthermore, to use the addition of a suitable catalyst to control the inter-molecular polycondensation reaction as well as by choice of a suitable temperature. Moreover, the composition of the starting components and the residence time can be used to adjust the average molecular weight of the polymers.

The polymers, obtained at elevated temperature, are typically stable at room temperature for a prolonged period, for example for at least 6 weeks, without clouding, precipitation and/or viscosity increase.

There are various ways to discontinue the intermolecular polycondensation reaction. For example, the temperature can be lowered into a range in which the reaction ceases and the polycondensation product is stable in storage. To this end, the temperature is typically lowered to below 60° C., preferably below 50° C., more preferably below 40° C. and most preferably to room temperature.

Alternatively, the polycondensation reaction can also be discontinued by deactivating the catalyst. In the case of basic catalysts this is done for example by adding an acidic component, such as a Lewis acid or an organic or inorganic protic acid. In the case of acidic catalysts, this is done for example by adding a basic component, such as a Lewis base or an organic or inorganic base.

It is further possible to stop the reaction by diluting with a precooled solvent. This is preferable, in particular, when the viscosity of the reaction mixture has to be adjusted by addition of solvent.

The high-functionality high-branched polyether amine polyols of the present invention generally have a glass transition temperature of less than 50° C., preferably less than 30° C. and more preferably less than 10° C.

The OH number of the high-branched polyether amine polyols of the present invention is typically 50 mg KOH/g or more and preferably 150 mg KOH/g or more. The OH number indicates the amount, in milligrams, of potassium hydroxide that is equivalent to the acetic acid quantity bound by one gram of substance in an acetylation. It is typically determined in accordance with German standard specification DIN 53240 Part 2.

The invention also provides amino-modified high-branched polyether amines obtainable from high-branched polyether amine polyols by reacting on average at least 1% and preferably at least 5% of the terminal hydroxyl groups with reagents having at least one primary or secondary amino group and a reactive group suitable for coupling with the terminal hydroxyl groups of the high-branched polyether amine polyol. The reactive group may be for example an alcohol, carboxylic acid, carboxylic anhydride, carbonyl chloride, amine or amide group, preferably an alcohol, carboxylic acid, carboxylic anhydride or carbonyl group and more preferably an alcohol group. The coupling reaction may be for example an etherification, an esterification, a transamination or a reaction with cyclic amides such as caprolactam for example. Etherifications are preferred coupling reactions.

The invention also provides a process for preparing amino-modified high-branched polyether amines, which comprises reacting a high-branched polyether amine polyol with a reagent having at least one primary or secondary amino group and a reactive group suitable for covalent coupling with the terminal hydroxyl groups of the high-branched polyether amine polyol. The reactive group may be for example an alcohol, carboxylic acid, carboxylic anhydride, carbonyl chloride, amine or amide group, preferably an alcohol, carboxylic acid, carboxylic anhydride or carbonyl group and more preferably an alcohol group.

Useful reagents for reacting the terminal hydroxyl groups of high-branched polyether amine polyols include for example monohydric or polyhydric aminoalcohols, preferably monohydric aminoalcohols, capable of forming ether bonds with the terminal hydroxyl groups of high-branched polyether amine polyol. Such aminoalcohols are for example linear or branched, aliphatic or aromatic alcohols. Such aminoalcohols, used for introducing secondary or primary amino groups, are preferably aliphatic aminoalcohols having 2 to 40 carbon atoms and also aromatic-aliphatic or aromatic-cycloaliphatic aminoalcohols having 6 to 20 carbon atoms and aromatic structures with heterocyclic or isocyclic ring systems. Examples of suitable aliphatic aminoalcohols are N-(2-hydroxyethyl)ethylenediamine, ethanolamine, propanolamine, butanolamine, diethanolamine, dipropanolamine, dibutanolamine, 1-amino-3,3-dimethyl-5-pentanol, 2-aminohexane-2′,2″-diethanolamine, 1-amino-2,5-dimethyl-4-cyclohexanol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclo-pentanemethanol, 2-amino-2-ethyl-1,3-propandiol and 2-(dimethylaminoethoxy)ethanol. Examples of suitable aromatic-aliphatic or aromatic-cycloaliphatic aminoalcohols are naphthalene or, more particularly, benzene derivatives such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propandiol.

An amino-modified high-branched polyether amine for the purposes of this invention is a product which, in addition to the ether groups and the amino groups, which form the polymer scaffold, further has, in a terminal position, at least three, preferably at least six, more preferably at least ten and even more preferably at least 20 functional groups. These functional groups are hydroxyl groups to which is coupled on average at least 1% and preferably at least 5% of a reagent having at least one primary or secondary amino group. The reagent is preferably coupled via an ether bridge. The number of terminal functional groups has no upper limit in principle, but products having a very large number of functional groups can have undesired properties, for example high viscosity or poor solubility. The amino-modified high-branched polyether amines of the present invention usually have not more than 500 and preferably not more than 150 terminal functional groups.

The weight average molecular weight (Mw) of the high-branched polyether amines is usually in the range from 1000 to 500 000 g/mol and preferably in the range from 2000 to 300 000 g/mol.

The high-branched polyether amines have trialkanolamines, for example triethanolamine, tripropanolamine, triisopropanolamine or tributanolamine, optionally combined with dialkanol-amines and/or polyetherols as monomer units, the monomer units in the high-branched polyether amine being linked together via their hydroxyl groups to form ether bridges.

High-branched polyether amine has been described for example for coating surfaces (WO 2009/047269) or for producing nanocomposites (WO 2009/115535).

The high-branched polyether amine content of the curable composition of the present invention is preferably in the range from 0.1% to 20% by weight and more preferably in the range from 1% to 10% by weight.

Epoxy compounds according to this invention have 2 to 10, preferably 2 to 6, more preferably 2 to 4 and especially 2 epoxy groups. The epoxy groups are more particularly glycidyl ether groups as formed in the reaction of alcohol groups with epichlorohydrin. The epoxy compounds can be low molecular weight compounds, which generally have an average molecular weight (Mn) below 1000 g/mol, or comparatively high molecular weight compounds (polymers). The epoxy compounds typically have a degree of oligomerization in the range from 1 to 25 monomer units. They can also be aliphatic, including cycloaliphatic compounds, or compounds having aromatic groups. More particularly, the epoxy compounds are compounds having two aromatic or aliphatic 6-rings or oligomers thereof. Of technical/industrial importance are epoxy compounds obtainable by reaction of epichlorohydrin with compounds having at least two reactive hydrogen atoms, more particularly with polyols. Of particular importance are epoxy compounds obtainable by reaction of epichlorohydrin with compounds comprising at least two, preferably exactly two hydroxyl groups and two aromatic or aliphatic 6-rings. Compounds of this type are more particularly bisphenol A and bisphenol F and also hydrogenated bisphenol A and bisphenol F. Bisphenol A diglycidyl ethers (DGEBAs) for example are used as epoxy compounds according to this invention. Other suitable possibilities are reaction products of epichlorohydrin with other phenols, for example with cresols or phenol-aldehyde adducts, such as phenol-formaldehyde resins, more particularly novolaks. Epoxy compounds not derived from epichlorohydrin are also suitable. Possibilities include, for example, epoxy compounds comprising epoxy groups as a result of reaction with glycidyl (meth)acrylate.

Amino hardeners for the purposes of the present invention are compounds having at least one primary amino group or having at least two secondary amino groups. Proceeding from epoxy compounds having at least two epoxy groups, curing can be effected via a polyaddition reaction (chain extension) with an amino compound having at least two amino functions. The functionality of an amino compound corresponds to its number of NH bonds. A primary amino group thus has a functionality of 2, while a secondary amino group has a functionality of 1. The linking of amino groups of the amino hardener with the epoxy groups of the epoxy compound leads to the formation of oligomers from the amino hardener and the epoxy compound wherein the epoxy groups are converted into free OH groups. Preference is given to using amino hardeners having a functionality of at least 3 (for example at least 3 secondary amino groups or at least one primary and one secondary amino group), more particularly those having two primary amino groups (functionality of 4). Preferred amino hardeners are isophoronediamine (IPDA), dicyandiamide (DICY), diethylenetriamine (DETA), triethylenetetramine (TETA), bis(p-aminocyclohexyl)methane (PACM), D230 polyether amine, Dimethyl Dicykan (DMDC), diaminodiphenylmethane (DDM), diaminodiphenyl sulfone (DDS), 2,4-toluenediamine, 2,6-toluenediamine, 2,4-diamino-1-methylcyclohexane, 2,6-diamino-1-methylcyclohexane, 2,4-diamino-3,5-diethyltoluene and 2,6-diamino-3,5-diethyltoluene and also mixture thereof. Particularly preferred amino hardeners for the curable composition of the present invention are isophoronediamine (IPDA), dicyandiamide (DICY) and D230 polyether amine.

The curable composition of the present invention preferably utilizes epoxy compound and amino hardener in an approximately stoichiometric ratio based on the number of epoxy groups on the one hand and the amino functionality on the other. Particularly suitable ratios are in the range from 1:0.8 to 1:1.2 for example.

Anhydride hardeners for the purposes of the present invention are organic compounds having at least one and preferably exactly one intramolecular carboxylic anhydride group. Preferred anhydride hardeners are succinic anhydride (SCCA), phthalic anhydride (PA), tetra-hydrophthalic anhydride (THPA), hexahydrophthalic anhydride (HHPA), methyltetrahydro-phthalic anhydride (MTHPA), methylhexahydrophthalic anhydride (MHHPA), endo-cis-bicyclo-[2.2.1]-6-methyl-5-heptene-2,3-dicarboxylic anhydride (Nadic Methyl Anhydride, NMA), dodecenylsuccinic anhydride (DDSA), pyromellitic dianhydride (PMDA), trimellitic anhydride (TMA) and benzophenonetetracarboxylic dianhydride (BTDA) and also mixtures thereof. MHHPA and NMA are particularly preferred anhydride hardeners for the curable composition of the present invention.

The curable composition of the present invention preferably utilizes epoxy compound and anhydride hardener in an approximately stoichiometric ratio based on the number of epoxy groups on the one hand and the anhydride groups on the other. Particularly suitable ratios are in the range from 1:0.8 to 1:1.2 for example.

Curable compositions of the present invention are for example the combination comprising diglycidyl ether of bisphenol A (DGEBA), isophoronediamine (IPDA) and high-branched polyether amine, the combination comprising DGEBA, IPDA and high-branched amino-modified polyether amine, the combination comprising DGEBA, D230 polyether amine and high-branched polyether amine, the combination comprising DGEBA, D230 polyether amine and high-branched amino-modified polyether amine, the combination comprising DGEBA, dicyandiamide (DICY) and high-branched polyether amine, the combination comprising DGEBA, DICY and high-branched amino-modified polyether amine, the combination comprising DGEBA, methylhexahydrophthalicanhydride (MHHPA) and high-branched polyether amine, the combination comprising DGEBA, MHHPA and high-branched amino-modified polyether amine, the combination comprising DGEBA, Nadic Methyl Anhydride (NMA) and high-branched polyether amine, and the combination comprising DGEBA, NMA and high-branched amino-modified polyether amine.

The curable composition of the present invention can be not only a liquid but also solid compositions comprising epoxy compound, amino or anhydride hardener and high-branched polyether amine. Liquid compositions are preferred. In accordance with the desired use, the compositions may comprise liquid components (epoxy compound, amino or anhydride hardener and high-branched polyether amine) or solid components. Mixtures of solid and liquid components can also be used for example as solutions or dispersions. Mixtures of solid components are used for example for powder coatings. Liquid compositions are particularly of importance for the production of fiber-reinforced composite materials of construction. The physical state of the epoxy compound can be adjusted via the degree of oligomerization in particular.

The curable composition of the present invention, incorporating the addition of high-branched polyether amine, provides an accelerated cure compared with the corresponding formulation without this addition. The extent to which the cure is accelerated is preferably at least 5%, more preferably at least 10% and more particularly at least 20%. The degree of cure acceleration can be more particularly determined by measuring the time to reaching a fixed viscosity of 10 000 mPas for the composition of the present invention compared with the corresponding composition without addition of high-branched polyether amine under otherwise identical curing conditions. The degree of cure acceleration can also be determined by measuring the time until the composition of the present invention becomes hard on a heated hotplate under constant agitation compared with the corresponding composition without addition of high-branched polyether amine under otherwise identical curing conditions. Advantageously, the high molar mass of the high-branched polyether amine means that it does not migrate within and/or out of the cured epoxy resin and also does not off-gas during processing.

The curable composition of the present invention preferably utilizes high-branched polyether amines having a similar viscosity to the epoxy compound used in the composition. In such a case, the typically low-viscosity hardener can initially be mixed with the high-branched polyether amine to form a pre-formulation. This pre-formulation and the epoxy compound of similar viscosity can then be efficiently and uniformly mixed with each other shortly before curing (to form a molded article for example). The viscosities of these components (pre-formulation and epoxy compound) at the mixing temperature preferably differ by not more than a factor of 20, more preferably by not more than a factor of 10 and more particularly by not more than a factor of 5, while it is preferable to choose a mixing temperature which is from 0 to 20° C. and more preferably from 0 to 10° C. below the curing temperature chosen. To produce carbon fiber-reinforced or glass fiber-reinforced composite materials of construction, the temperature chosen for mixing the components and filling the mold, which involves the fibers being wetted, is preferably a temperature at which the epoxy compound used has viscosity of not more than 200 mPas, more preferably not more than 100 mPas and more particularly in the range from 20 to 100 mPas. Mixing liquids of similar viscosities is typically accomplished better and more uniformly than mixing liquids having very different viscosities. Therefore, the use of such pre-formulations, which have a viscosity adapted to the epoxy compound, makes it possible to produce molded articles in cured epoxy resin which are better and more uniform in their capacity as a material.

In addition, the cured epoxy resins of the present invention have improved mechanical properties compared with the cured epoxy resins obtained from a corresponding composition without addition of high-branched polyether amine. The cured epoxy resins of the present invention are distinctly improved with regard to flexural strength, flexural modulus and also flexural elongation. These parameters can be determined for example in the 3-point bending test as per ISO 178:2006.

The examples which follow illustrate the present invention.

### Examples 1 and 2

Preparing the high-branched polyether amine polyols polyTEA (Example 1) and polyTIPA

### Example 2

A four-neck flask equipped with stirrer, distillation bridge, gas inlet tube and internal thermometer was initially charged with 2000 g of triethanolamine (TEA; Ex. 1) or triisopropanolamine (TIPA; Ex. 2) and also 13.5 g of hypophosphorous acid as 50% aqueous solution and the mixture heated to 230° C. The formation of condensate ensued at about 220° C. The reaction mixture was stirred at 230° C. for the time reported in Table 1, while the water formed in the course of the reaction was removed via the distillation bridge using a moderate stream of N₂ as stripping gas. Toward the end of the reported reaction time, remaining water of reaction was removed at an under pressure of 500 mbar.

On reaching the desired degree of conversion the batch was cooled down to 140° C. and the pressure was slowly and incrementally lowered to 100 mbar to remove any remaining volatiles. The product mixture was subsequently cooled down to room temperature and analyzed.

### Example 3

### Preparation of High-Branched Amino-Modified polyTEA

A four-neck flask equipped with stirrer, distillation bridge, gas inlet tube and internal thermometer was initially charged with 500 g of polytriethanolamine (polyTEA, Ex. 1) and 138 g of N-(2-hydroxyethyl)ethylenediamine. The mixture was then heated to 230° C. and stirred for 4.5 h, while the water formed in the course of the reaction was removed via the distillation bridge using a moderate stream of N₂ as stripping gas. Toward the end of the reported reaction time, remaining water of reaction was removed at an under pressure of 500 mbar.

On reaching the desired degree of conversion the batch was cooled down to 140° C. and the pressure was slowly and incrementally lowered to 100 mbar to remove any remaining volatiles. The product mixture was subsequently cooled down to room temperature and analyzed.

### Example 4

### Preparation of high-branched amino-modified polyTIPA

A four-neck flask equipped with stirrer, distillation bridge, gas inlet tube and internal thermometer was initially charged with 600 g of polytriisopropanolamine (polyTIPA, Ex. 2) and 208 g of N-(2-hydroxyethyl)ethylenediamine. The mixture was then heated to 230° C. and stirred for 4.5 h, while the water formed in the course of the reaction was removed via the distillation bridge using a moderate stream of N₂ as stripping gas. Toward the end of the reported reaction time, remaining water of reaction was removed at an under pressure of 500 mbar.

On reaching the desired degree of conversion the batch was cooled down to 140° C. and the pressure was slowly and incrementally lowered to 100 mbar to remove any remaining volatiles. The product mixture was subsequently cooled down to room temperature and analyzed.

### Example 5

### Analysis of High-Branched Polyether Amines from Examples 1 to 4

The polyether amines were analyzed by gel permeation chromatography (GPC) using a rerfractometer as detector. The mobile phase used was hexafluoroisopropanol (HFIP), and polymethyl methacrylate (PMMA) was used as standard to determine the molecular weight (weight average molecular weight (Mw) and number average molecular weight (Mn)). OH number was determined to DIN 53240 Part 2.

Amine number indicates the amount, in milligrams, of potassium hydroxide corresponding to the amine basicity of one gram of test compound. It was determined as per ASTM D 2074.

The analytical results are collated in Table 1.

TABLE 1
Starting materials and end products

| Ex. | 1 | 2 | 3 | 4 |
|---|---|---|---|---|
| Reaction time (h) | 4 | 0.2 | | |
| Mass of water of reaction (g) | 245 | 36 | 39 | 50 |
| Mw by GPC (g/mol) | 6500 | 4220 | 13 000 | 5980 |
| Mn by GPC (g/mol) | 3800 | 3560 | 5500 | 4290 |
| OH number of product | 595 | 747 | 611 | 750 |
| (mg KOH/g) | | | | |
| Amine number for all amino | 410 | 297 | 555 | 477 |
| groups (mg KOH/g) | | | | |
| Amine number of tert. amino | 406 | 296 | 436 | 294 |
| groups (mg KOH/g) | | | | |

### Example 6

### Rheological Investigation of Epoxy Compositions with Isophoronediamine as Hardener and Addition of High-Branched Polyether Amines

5 g each of the high-branched polyether amines of Examples 1 to 4 were each mixed with 100 g of a low-viscosity and solvent-free epoxy resin of the bisphenol A type (Epilox A 19-03 from LEUNA-Harze GmbH) and 23.6 g of the cycloaliphatic amino hardener isophoronediamine (IPDA from BASF SE). A batch formed from the same amounts of epoxy resin and IPDA without addition of a high-branched polyether amine was used as reference. The reactivity of the epoxy compositions was investigated by measuring the viscosity of the epoxy compositions over time at 40° C. using a plate-plate rheometer (MCR300 from Anton Paar GmbH, Austria). The reaction time at which the particular epoxy composition reached a viscosity of 10 000 mPas was determined as a measure of reactivity. The results are collated in Table 2.

### Example 7

### Rheological Investigation of Epoxy Compositions with D230 Polyether Amine as Hardener and Addition of High-Branched Polyether Amines

5 g each of the high-branched polyether amines of Examples 1 to 4 were each mixed with 100 g of a low-viscosity and solvent-free epoxy resin of the bisphenol A type (Epilox A 19-03 from LEUNA-Harze GmbH) and 33.5 g of the D230 amino hardener (from BASF SE), an aliphatic linear polyether amine. A batch formed from the same amounts of epoxy resin and D230 without addition of a high-branched polyether amine was used as reference. The reactivity of the epoxy compositions was investigated by measuring the viscosity of the epoxy compositions over time at 40° C. using a plate-plate rheometer (MCR300 from Anton Paar GmbH, Austria). The reaction time at which the particular epoxy composition reached a viscosity of 10 000 mPas was determined as a measure of reactivity. The results are collated in Table 2.

### Example 8

### Rheological Investigation of Epoxy Compositions with Dicyandiamide as Hardener and Addition of High-Branched Polyether Amines

5 g each of the high-branched polyether amines of Examples 1 to 4 were each mixed with 100 g of a low-viscosity and solvent-free epoxy resin of the bisphenol A type (Epilox A 19-03 from LEUNA-Harze GmbH) and 6.52 g of the latent amino hardener dicyandiamide (DICY, Dyhard 100SH from AlzChem Trostberg GmbH), which is used in 1-pack epoxy systems in particular. A batch formed from the same amounts of epoxy resin and DICY without addition of a high-branched polyether amine was used as reference. The reactivity of the epoxy compositions was investigated by measuring the viscosity of the epoxy compositions over time at 140° C. using a plate-plate rheometer (MCR300 from Anton Paar GmbH, Austria). The reaction time at which the particular epoxy composition reached a viscosity of 10 000 mPas was determined as a measure of reactivity. The test was discontinued on expiration of 60 min. The results are collated in Table 2.

### Example 9

### Determining the Thermal Properties of Epoxy Compositions with Isophoronediamine as Hardener and Addition of High-Branched Polyether Amines by Differential Scanning Calorimetry (DSC)

The epoxy compositions with isophoronediamine as hardener and addition of high-branched polyether amine and the corresponding reference were prepared as described in Ex. 6. DSC analysis was carried out as per ASTM 3418/82. The onset temperature (Tₒ), the temperature of peak maximum (Tₘₐₓ) and the glass transitional temperature (T_{g}) were determined. The results are summarized in Table 2.

TABLE 2
Rheologically determined reaction time and DSC analysis

| | | | 5 g of | 5 g of | |
|---|---|---|---|---|---|
| | | | amino- | amino- | |
| Polyether | 5 g of | 5 g of | modified | modified | |
| amine | polyTEA | polyTIPA | polyTEA | polyTIPA | Refer- |
| addition | from Ex. 1 | from Ex. 2 | from Ex. 3 | from Ex. 4 | ence |
| Reaction time | 38 | 29 | 52 | 40 | 69 |
| for IPDA cure | | | | | |
| as per Ex. 6 | | | | | |
| (min) | | | | | |
| Reaction time | 165 | 116 | 185 | 156 | 195 |
| for D230 cure | | | | | |
| as per Ex. 7 | | | | | |
| (min) | | | | | |
| Reaction time | 6 | >60 | 4 | 18 | >60 |
| for DICY cure | | | | | |
| as per Ex. 8 | | | | | |
| (min) | | | | | |
| Tₒ for IPDA | 66.8 | 47.3 | 62.6 | 53.0 | 74.3 |
| cure as per | | | | | |
| Ex. 9 (° C.) | | | | | |
| Tₘₐₓ for IPDA | 96 | 90.5 | 96.7 | 95.1 | 100.8 |
| cure as per | | | | | |
| Ex. 9 (° C.) | | | | | |
| T_{g} for IPDA | 146.4 | 143.8 | 149.7 | 145.7 | 158 |
| cure as per | | | | | |
| Ex. 9 (° C.) | | | | | |

### Example 10

### Determining the Pot Life of Epoxy Compositions with Isophoronediamine as Hardener and Addition of High-Branched Polyether Amines

The epoxy compositions with isophoronediamine (IPDA) as hardener and with addition of high-branched polyether amine as per Example 2 and Example 4 and also the corresponding reference without addition of high-branched polyether amine were prepared as described in Ex. 6. To analyze the pot life, 100 g of the curable composition in each case were measured for reaction temperature by thermal scanning. Pot life is the time to maximum reaction temperature. It corresponds to the time during which the viscosity of the curable composition is low enough for processing of the composition to be possible. Maximum temperature and pot life were determined. The corresponding epoxy composition with the high-branched polyether amine as per Example 2 has a pot life of 43 min and a maximum temperature of 226° C. and that with the high-branched polyether amine as per Example 4 has a pot life of 66.9 min and a maximum temperature of 226° C., while the reference composition has a pot life of 137 min and a maximum temperature of 174° C.

### Example 11

### Determining the Thermal Properties of Epoxy Compositions with Dicyandiamide (DICY) as Hardener and Addition of High-Branched Polyether Amines by Differential Scanning Calorimetry (DSC)

The epoxy compositions with dicyandiamide (DICY) as hardener and addition of high-branched polyether amine and the corresponding reference without addition of high-branched polyether amine were prepared as described in Ex. 8. DSC analysis was carried out as per ASTM 3418/82. The onset temperature (Tₒ), the temperature of peak maximum (Tₘₐₓ) and the glass transitional temperature (T_{g}) were determined. The results are summarized in Table 3.

### Example 12

### Determining the Hardening Time of Epoxy Compositions with Dicyandiamide (DICY) as Hardener and Addition of High-Branched Polyether Amines

Hardening time determination was done on a B-time plate at 160° C. The epoxy compositions with dicyandiamide (DICY) as hardener and addition of high-branched polyether amine and the corresponding reference without addition of high-branched polyether amine were prepared as described in Ex. 8 and dripped onto the hot plate at 160° C. The mixture was then constantly hand stirred with a wooden rod until it became hard. The time for this is the hardening time. The measurements are collated in Table 3. Compared with the hardening time of the reference, the epoxy compositions with addition of high-branched polyether amines exhibited a distinctly shortened hardening time. Adding these high-branched polyether amines thus had a distinctly accelerating effect on the cure.

TABLE 3
Rheologically determined reaction time and DSC analysis

| | | | 5 g of | 5 g of | |
|---|---|---|---|---|---|
| | | | amino- | amino- | |
| Polyether | 5 g of | 5 g of | modified | modified | |
| amine | polyTEA | polyTIPA | polyTEA | polyTIPA | Refer- |
| addition | from Ex. 1 | from Ex. 2 | from Ex. 3 | from Ex. 4 | ence |
| To for DICY | 122.6 | 175.2 | 118.7 | 147.1 | 181.3 |
| cure as per | | | | | |
| Ex. 10 (° C.) | | | | | |
| Tₘₐₓ for DICY | 136.7 | 185 | 131.6 | 159.1 | 190.6 |
| cure as per | | | | | |
| Ex. 10 (° C.) | | | | | |
| T_{g} for DICY | 129.9 | 123.1 | 139.7 | 124.6 | 138.4 |
| cure as per | | | | | |
| Ex. 10 (° C.) | | | | | |
| Hardening time | 10.25 | 56 | 2.12 | 12.23 | 79 |
| as per Ex. 12 | | | | | |
| at 160° C. | | | | | |
| (min) | | | | | |

### Example 13

### Determining the Mechanical Properties of Cured Epoxy Resins from Epoxy Compositions with Isophoronediamine as Hardener and Addition of High-Branched Polyether Amines

The epoxy compositions with isophoronediamine (IPDA) as hardener and with addition of high-branched polyether amine as per Example 1 (polyTEA) and Example 2 (polyTIPA) and also the corresponding reference without addition of high-branched polyether amine were prepared as described in Ex. 6. Curing was done by heating to 80° C. for 2 h and then to 125° C. for 3 h. The cured samples were tested for flexural strength, flexural modulus and flexural elongation. The results are collated in Table 4. The addition of high-branched polyether amines to the epoxy composition provides cured epoxy resins having distinctly improved mechanical properties.

TABLE 4
Mechanical testing

| | 5 g of | 5 g of | |
|---|---|---|---|
| Polyether amine | polyTEA | polyTIPA | Refer- |
| addition | from Ex. 1 | from Ex. 2 | ence |
| Flexural strength (MPa) | 132.2 | 132.1 | 112.0 |
| Flexural modulus | 3099 | 3061 | 2888 |
| (MPa) | | | |
| Flexural elongation (%) | 6.1 | 6.1 | 5.7 |

### Example 14

### Rheological Investigation and Determining the Hardening Time of Epoxy Compositions with Methylhexahydrophthalicanhydride as Hardener and Addition of High-Branched Polyether Amines

5 g each of the high-branched polyether amines of Examples 1 to 4 were each mixed with 100 g of a low-viscosity and solvent-free epoxy resin of the bisphenol A type (Epilox A 19-03 from LEUNA-Harze GmbH) and 85 g of the anhydride hardener methylhexahydrophthalicanhydride (MHHPA from ACROS Organics). A batch formed from the same amounts of epoxy resin and MHHPA without addition of a high-branched polyether amine was used as reference. The reactivity of the epoxy compositions was investigated by measuring the viscosity of the epoxy compositions over time at 120° C. using a plate-plate rheometer (MCR300 from Anton Paar GmbH, Austria). The reaction time at which the particular epoxy composition reached a viscosity of 10 000 mPas was determined as a measure of reactivity. The determinations of the reaction time for the reference were discontinued after 120 min. The results are collated in Table 5.

Hardening time determination was done on a B-time plate at 160° C. The epoxy compositions with MHHPA as hardener and addition of high-branched polyether amine and the corresponding reference were dripped onto the hot plate at 160° C. The mixture was then constantly hand stirred with a wooden rod until it became hard. The time for this is the hardening time. The determinations of the hardening time were discontinued after 120 min for the reference and after 30 min at the latest for the samples with addition of high-branched polyether amine. The results are collated in Table 5.

### Example 15

### Rheological Investigation and Determining the Hardening Time of Epoxy Compositions with Nadic Methyl Anhydride as Hardener and Addition of High-Branched Polyether Amines

5 g each of the high-branched polyether amines of Examples 1 to 4 were each mixed with 100 g of a low-viscosity and solvent-free epoxy resin of the bisphenol A type (Epilox A 19-03 from LEUNA-Harze GmbH) and 85 g of the Nadic Methyl Anhydride anhydride hardener (NMA from Fluka). A batch formed from the same amounts of epoxy resin and NMA without addition of a high-branched polyether amine was used as reference. The reactivity of the epoxy compositions was investigated by measuring the viscosity of the epoxy compositions over time at 120° C. using a plate-plate rheometer (MCR300 from Anton Paar GmbH, Austria). The reaction time at which the particular epoxy composition reached a viscosity of 10 000 mPas was determined as a measure of reactivity. The determinations of the reaction time for the reference were discontinued after 120 min. The results are collated in Table 5.

Hardening time determination was done on a B-time plate at 160° C. The epoxy compositions with NMA as hardener and addition of high-branched polyether amine and the corresponding reference were dripped onto the hot plate at 160° C. The mixture was then constantly hand stirred with a wooden rod until it became hard. The time for this is the hardening time. The determinations of the hardening time were discontinued after 120 min for the reference and after 30 min at the latest for the samples with addition of high-branched polyether amine. The results are collated in Table 5.

TABLE 5
Rheologically determined reaction time
and determination of hardening time

| | | | 5 g | 5 g of | |
|---|---|---|---|---|---|
| | | | amino- | amino- | |
| Polyether | 5 g of | 5 g of | modified | modified | |
| amine | polyTEA | polyTIPA | polyTEA | polyTIPA | Refer- |
| addition | from Ex. 1 | from Ex. 2 | from Ex. 3 | from Ex. 4 | ence |
| Reaction time | 6.1 | 39.5 | 9 | 18.4 | >120 |
| for MHHPA | | | | | |
| cure at 120° C. | | | | | |
| (min) | | | | | |
| Hardening time | 1.6 | >30 | 1.7 | 8 | >120 |
| for MHHPA | | | | | |
| cure at 160° C. | | | | | |
| (min) | | | | | |
| Reaction time | 11.6 | 68.7 | 13.3 | 32.4 | >120 |
| for NMA cure | | | | | |
| at 120° C. | | | | | |
| (min) | | | | | |
| Hardening time | 3 | >30 | 2.9 | >30 | >120 |
| for NMA cure | | | | | |
| at 160° C. | | | | | |
| (min) | | | | | |

1. A curable composition comprising at least one epoxy compound, at least one amino or anhydride hardener and at least one high-branched polyether amine, wherein the epoxy compounds has 2 to 10 epoxy groups.

2. The curable composition according to claim 1, wherein the hardener is an amino hardener having at least one primary or two secondary amino groups.

3. The curable composition according to claim 1, wherein the hardener is an anhydride hardener having at least one intramolecular carboxylic anhydride group.

4. The curable composition according to claim 1, wherein the high-branched polyether amine is a high-branched polyether amine polyol having at least 3 terminal hydroxyl groups.

5. The curable composition according claim 1, wherein the high-branched polyether amine is an amino-modified high-branched polyether amine having at least three terminal hydroxyl groups coupled with on average at least 1% of the reagent having at least one primary or secondary amino group.

6. The curable composition according to claim 5, wherein the reagent is a mono- or polyhydric aminoalcohol.

7. The curable composition according to claim 1, wherein the high-branched polyether amine comprises triethanolamine, tripropanolamine, triisopropanolamine or tributanolamine as monomer unit, the monomer units in the polyether amine being linked to each other via their hydroxyl groups to form ether bridges.

8. The curable composition according to claim 1, wherein the high-branched polyether amine has a weight average molecular weight of 1,000 to 500,000 g/mol.

9. A process for preparation of cured epoxy resin, which process comprises curing a curable composition according to claim 1.

10. A cured epoxy resin obtainable by curing a curable composition according to claim 1.

11. A cured epoxy resin from the curable composition according to claim 1.

12. A molded article from the cured epoxy resin according to claim 10.

13. A high-branched polyether amine having at least 3 terminal hydroxyl groups coupled with on average at least 1% of a reagent having at least one primary or secondary amino group.

14. A high-branched polyether amine obtainable from high-branched polyether amine polyol by reacting on average at least 1% of the terminal hydroxyl groups with a reagent having at least one primary or secondary amino group and a reactive group suitable for coupling with the terminal hydroxyl groups of the high-branched polyether amine polyol.

15. The high-branched polyether amine according to claim 13, wherein the reagent is a mono- or polyhydric aminoalcohol.

16. A process for preparing an amino-modified high-branched polyether amine, which process comprises reacting a high-branched polyether amine polyol with a reagent having at least one primary or secondary amino group and a reactive group suitable for coupling with the terminal hydroxyl groups of the high-branched polyether amine polyol.

17. A method for speeding the curing of a curable composition comprising adding at least one epoxy compound having 2 to 10 epoxy groups and at least one amino or anhydride hardener to a curable composition.
